(19) United States
(12) Patent Application Publication
(10) Pub. No.: US 2026/0317060 A1
(43) Pub. Date: Oct. 15, 2026

(54) MODULAR CONTAINER HANDLING DEVICE

(71) Applicant: AutoStore Technology AS, Nedre Vats (NO)

(72) Inventor: Stig Paulsen, Drammen (NO)

(21) Appl. No.: 19/485,991

(22) PCT Filed: Jun. 17, 2024
(86) PCT No.: PCT/EP2024/066799

§ 371 Date: Nov. 19, 2025

(30) Foreign Application Priority Data
Jun. 19, 2023 (NO) 20230701

(51) Int. Cl. B65G 1/04

(52) U.S. Cl. CPC B65G 1/0464; B65G 2207/30

(57) ABSTRACT

A modular container handling vehicle for use in an automated storage and retrieval system, the vehicle being assembled from a kit of parts having three modules types, the first and third module types having drive wheels and drive motors, the second module type having a lifting device for lifting containers.

The present application relates to a modular container handling vehicle configurable from a kit comprising a first module, a second module and a third module, which modules can be arranged in various configurations.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b, 301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Various Vehicle Configurations

As described above and as illustrated in FIGS. 2 and 3, certain container handling vehicles are configured with the lifting device arranged to lift containers into central cavity of the vehicle (see prior art FIG. 2), while other vehicles are configured with the lifting mechanism arranged on an outwardly projecting cantilever arm (see FIG. 3). Each of these variations of container handling vehicle have their own inherent advantages, and the owner of a facility will generally choose one or the other depending upon the needs of the particular facility. If the owner of the facility that has acquired vehicles of one type encounters a need for vehicles with another configuration, however, the owner would need to acquire a new set of vehicles and perhaps retire the previous set of vehicles. This is an expensive and cumbersome proposition. There is a need, therefore, for a modular vehicle that can be selectively assembled in various configurations.

### SUMMARY

The presently claimed invention is set forth and characterized in the independent claims, while the dependent claims describe other characteristics of the presently claimed invention.

The disclosure provides a container handling vehicle comprised of essentially three module types, and a kit comprising such modules adapted to permit assembling a container handling vehicle in various configurations. First and third module types comprise drive wheels and associated drive motors, while a second module type comprises the lifting mechanism for lifting and lowering containers.

In a first aspect, the modules may be assembled such that the module with the lifting device is arranged between the modules with the drive wheels, thus forming a vehicle with a central cavity similar in function to the prior art vehicle in FIG. 2. In other words, the vehicle according to this aspect is arranged as follows:
Wheel module>lifting module>wheel module

In a second aspect, the modules may also be assembled with the two modules containing drive wheels arranged next to each other, with the module containing the lifting device arranged at an outside position, so as to form a vehicle with a single, outwardly projecting cantilever arm similar in function to prior art vehicle illustrated in FIG. 3. The vehicle according to this aspect is arranged as follows:
Wheel module>wheel module>lifting module

In a third aspect, the modules may be assembled with the two modules containing drive wheels arranged next to each other, with two modules containing lifting devices arranged at opposite outside positions, so as to form a vehicle with two outwardly projecting cantilever arms. The vehicle according this aspect is arranged as follows:
Lifting module>wheel module>wheel module>lifting module

Accordingly, the disclosure provides a container handling vehicle (and in one aspect a kit for assembling such a vehicle) for operation on an automated storage and retrieval system, the automated storage and retrieval system comprising a two-dimensional rail system comprising a first set of parallel rails in a horizontal plane arranged to guide movement of container handling vehicles in a first direction across the top of a frame structure, and a second set of parallel rails in the horizontal plane arranged perpendicular to the first set of parallel rails to guide movement of the container handling vehicles in a second direction which is perpendicular to the first direction, the container handling vehicle comprising a first set of wheels for driving the vehicle in a first direction and a second set of wheels for driving the vehicle in a second direction, the first set of wheels comprising a first wheel, a second wheel, a third wheel and a fourth wheel for driving in the first direction and the second set of wheels comprising a first wheel, a second wheel, a third wheel and a fourth wheel for driving in the second direction, wherein the vehicle comprises three or more of a first module, a second module and a third module arranged side-by-side, with cross members connected between the first and third modules, and wherein the first module comprises the first wheel and the second wheel of the first set of wheels connected to a first drive motor for driving said first and second wheels of the first set of wheels, and the first wheel and the fourth wheels of the second set of wheels connected to a second drive motor for driving said first wheel and fourth wheels of the second set of wheels, and wherein
the second module comprises a frame having a footprint essentially equal to the footprint of a container of the storage system, the second module further comprising a lifting device including gripping mechanism for raising of lowering containers,
the third module comprises the third wheel and the fourth wheel of the first set of wheels connected to a third drive motor for driving said third and fourth wheels of the first set of wheels, and the second wheel and the third wheel of the second set of wheels connected to a fourth drive motor for driving said second and third wheels of the second set of wheels
with aspects comprising the following configurations, having the prescribed longitudinal order of arrangement of the modules:
a. first module, second module, third module
b. first module, third module, second module
c. second module, first module, third module, second module.

In another aspect, there is provided a kit of parts comprising a first module, one or more second modules, a third module and a plurality of cross members.

The first module, the second module and the third module are preferably arranged side-by-side with the next module in a horizontal plane.

When the second module is directly above a grid cell, the first module and/or third module may extend into a neighboring grid cell.

The first wheel and the fourth wheel of the second set of wheels is preferably operatively connected to the third drive motor by a drive band.

The container handling vehicle and/or kit may comprise a first lifting device motor, and the first lifting device motor may be arranged in the first module.

The container handling vehicle and/or kit may comprise a second lifting device motor, and the second lifting device motor may be arranged in the third module.

The second module, when arranged intermediate the first and third modules as in configuration “a” above, may provide a cavity in which a storage container may be accommodated, and the container handling vehicle may comprise a lifting device in the second section for lifting and lowering of the storage container into the cavity, and the first wheel and the fourth wheel of the second set of wheels may be arranged on a first side of the cavity and the second wheel and the third wheel of the second set of wheels may be arranged on an opposite second side of the cavity.

When the second module is arranged at an outside position as in aspects “b” or “c” above, the assembled vehicle will comprise one or two cantilever lifting arms, respectively.

The lifting device of the second module may comprise at least one rotatable lifting shaft configured to raise and lower the gripping mechanism via a set of lifting bands

The first module may have a footprint, the second module may have a footprint, and a size ratio of the footprint of the second module relative to the footprint of the first module may be at least 2:1.

The third module may have a footprint, and a size ratio of the footprint of the second module relative to the footprint of the third module may be at least 2:1.

If both the first module and the third module are smaller than half a grid cell width compared to the second module, this allows passing of two container handling vehicles having the same orientation on 5 grid cells instead of 6 cells because the two container handling vehicles share one grid cell, i.e. each of the container handling vehicles occupies less than 50% of the shared grid cell.

The first set of wheels may be arranged to be movable in a vertical direction relative to the vehicle between an upper position in which the second set of wheels allows movement of the vehicle along the second direction, and a lower position in which the first set of wheels allows movement of the vehicle along the first direction; and
each of the third wheel and the fourth wheel of the first set of wheels may be mounted to one of a pair of first wheel links, each first wheel link may comprise a first pivot coupling and a second pivot coupling and each first wheel link may be pivotably connected to the vehicle frame by the first pivot coupling;
each of the first wheel and the second wheel of the first set of wheels may be mounted to one of a pair of second wheel links, each second wheel link may comprise a third pivot coupling and a fourth pivot coupling and each first wheel link may be pivotably connected to the vehicle frame by the third pivot coupling;
the first wheel link and the second wheel link may be connected via the respective second and fourth pivot couplings by a first coupler link; and
the first wheel link and the second wheel link may be connected via the respective second and fourth pivot couplings by a second coupler link,
and wherein, when arranged as in aspect “a”, the first coupler link and the second coupler link extend on opposite sides of the cavity between the first side and the second side of the second section.

The first and second coupler links, when arranged as in aspect “a”, may extend either side of the cavity between the first and second sides of the second module. The third module may comprise an actuator assembly, the actuator assembly may be arranged to move the first wheel links around the respective first pivot couplings between a first angular position and a second angular position, the movement of the first wheel links may be transferred to the second wheel links via the first coupler link and the second coupler link, such that the first set of wheels may be in the upper position or the lower position when the first wheel links are in the first angular position or the second angular position, respectively.

Cross members may be connected between the first and third modules. The cross member may provide rigidity to the assembled modules, and may have additional purposes. The first module may comprise a first cross-member fixing the angular position of the second wheel links relative to each other, such that the second wheel links will move in unison around their respective third pivot coupling; and
the third module may comprise a second cross-member fixing the angular position of the first wheel links relative to each other, such that the first wheel links will move in unison around their respective first pivot coupling; and
the actuator assembly may be operatively connected to a wheel lift mechanism and may be arranged to move the first wheel link around its first pivot coupling between the first angular position and the second angular position.

The first cross-member may be connected to both second wheel links such that the positions of the second wheel links are fixed relative to each other.

The second cross-member may be connected to both first wheel links, such that the positions of the first wheel links are fixed relative to each other.

The actuator assembly may be operatively connected between the vehicle framework and at least one of the first wheel links.

The actuator assembly may comprise a wheel lift motor or a linear actuator.

At least one of the first wheel links may comprise a fifth pivot coupling connected to the actuator assembly.

The actuator assembly may comprise an actuator link pivotably connected to one of the first wheel links. The actuator link may be used to drive rotation of the first wheel links.

The actuator link may be connected to the fifth pivot coupling of the at least one first wheel link.

The actuator link may be part of a movement transfer assembly configured to convert a rotational movement, or transfer a linear movement, of the actuator assembly to a substantially linear movement acting on the fifth pivot coupling of one of the first wheel links.

The container handling vehicle may comprise:
a first drive shaft arranged in the first module and interconnecting the second wheel links, wherein the first drive shaft is operatively connected to drive the first wheel and the second wheel of the first set of wheels; and
a second drive shaft arranged in the third module and interconnecting the second wheel links, wherein the second drive shaft is operatively connected to drive the third wheel and the fourth wheel of the first set of wheels.

The first drive shaft is preferably operatively connected to drive the first wheel and the second wheel via respective drive bands.

The second drive shaft is preferably operatively connected to drive the third wheel and the fourth wheel via respective drive bands.

The first drive shaft may be connected to a first drive such as an electric motor. Rotational movement of the first drive shaft may be transferred to the first wheel and the second wheel of the first set of wheels.

The second drive shaft may be connected to a second drive such as an electric motor. Rotational movement of the second drive shaft may be transferred to the third wheel and the fourth wheel of the first set of wheels.

The first drive shaft and the first cross-member and the second drive shaft and the second cross-member may be configured to move in parallel when the first wheel links and the second wheel links are moved between the first and second angular positions.

The first drive shaft and the second drive shaft may be configured to move in unison with the first wheel links and the second wheel links between the first and second angular position. By moving in unison with the first wheel links and the second wheel links and their respective supported wheels, both excessive wear of the drive bands due to stretching, and service involving tightening of the drive bands, are minimized. The belt lengths, and hence the belt tension remain constant and can be set to a preferred tension, since the wheels and motors supported by the first and second wheel links are fixed in a spatial relationship with respect to each other during the angular movement.

The first drive motor may be fixed to one of the first wheel links. The first drive shaft may have a first end and a second end, the first drive shaft may extend through a centerline of the first drive motor, such that the first end is operably connected to the first wheel of the first set of wheels and the second end is operatively connected to the second wheel of the first set of wheels. The first end may be operatively connected to the first wheel by a drive band, and the second end may be operatively connected to the third wheel by a drive band.

The second wheel and the third wheel of the second set of wheels is preferably operatively connected to the fourth drive motor by a drive band.

The first coupler link and the second coupler link may be configured to move in the first direction towards the first wheel and the second wheel of the first set of wheels, respectively, when the first wheel links are moved from the second angular position to the first angular position.

The first coupler link and the second coupler link are preferably plate-shaped providing a covering which closes off a lower portion of two sides of the container handling vehicle, or at least provides a barrier to the cavity of the second module when the vehicle is configured as in aspect “a” above.

Each of the coupler links may comprise a wheel recess for the wheel connected to the respective first wheel link. Each of the coupler links may feature a first end pivotably connected to the second pivot coupling of the respective second wheel link and is pivotably connected to the second pivot coupling of the respective first wheel link at a portion of the coupler link arranged above the wheel recess.

The coupler links may act as both force transferring elements between the wheel link arms and bodywork/covering closing off the lower portion of two sides of the container handling vehicle.

The first pivot coupling and the third pivot coupling may be arranged at a level below the second pivot coupling and the fourth pivot coupling.

A rechargeable battery may be arranged in the third module. Optionally or additionally a rechargeable battery may be arranged in the first module.

The container handling vehicle may comprise a set of electrodes for receiving power from a charging station, the electrodes are preferably arranged in the third module and connected to the rechargeable battery in the third module.

The container handling vehicle may comprise a control unit arranged in the third module.

The container handling vehicle may comprise a set of replaceable or adjustable distance pins, the distance pins configured to interact with switches or sensors on the lifting frame when the lifting frame is in an upper position.

The adjustable or replaceable distance pins ensure that the efficiency of the container handling vehicle may be optimized with respect to the height of the storage containers being lifted. The container handling vehicle may comprise four distance pins arranged to interact with four corner modules of the lifting frame. The distance pins may be configured to stabilize the lifting frame, and any storage container connected thereto, when the lifting frame is in an upper position.

The vehicle frame may comprise a first vertically extending subframe (e.g., a first vertical subframe) forming part of the first module and a second vertically extending subframe (e.g., a second vertical subframe) forming part of the third module. The vehicle frame may comprise a horizontally extending upper frame having a footprint essentially equal to the footprint of a container (e.g., a horizontal upper member) forming part of the second module, and the horizontally extending upper frame may be arranged above the cavity when the vehicle is configured as in aspect “a” above, or may form part of the cantilever arm when the vehicle is configured as in aspects “b” or “c” above. The horizontally extending upper frame may extend between the first vertically extending subframe and second vertically extending subframes of the first and third modules, or may project outward from such vertical subframes to form part of the cantilever arm.

The horizontally extending upper frame is preferably arranged over the lifting frame (in addition to be arranged over the cavity or forming part of a cantilever arm).

The horizontally extending upper frame may be connected to the first vertical subframe and/or the second vertical subframe.

The first and second vertical subframes may be arranged on opposite sides of the cavity in configuration “a”, or side by side in configuration “b” or “c”.

The vehicle frame may comprise side cross-members arranged on opposite sides of the cavity in configuration “a”, or between adjacent first and third modules in configuration “b” or “c”.

The side cross-members may be horizontal members connected to lower portions of the first and second vertical subframes. Alternatively, the side cross-members may form cross connections connected to a lower portion of one of the first or second vertical subframe and to an upper portion of the other of the first and second vertical subframe.

The first and second coupler links are preferably arranged below the side cross-members.

It is further described a container handling vehicle comprising a first module, a second module and a third module, the first module and the third module comprise drive motors on hinged wheel assemblies for driving wheels arranged in the respective first module and third module, and the hinged wheel assemblies of the first module and the third module may be connectable on opposite sides of the second module. As such, the container handling vehicle may be assembled from a kit of parts comprising the various components of the assembled vehicle.

It is further described an automated storage and retrieval system comprising a container handling vehicle as defined above, wherein the automated storage and retrieval system comprises a frame structure having a plurality of storage columns for accommodating vertical stacks of storage containers, the frame structure having a rail system upon which the container handling vehicle may move in two perpendicular directions above the storage columns. The automated storage and retrieval system may comprise a plurality of the container handling vehicles as defined above.

The automated storage and retrieval system may comprise a plurality of upright members and each storage column may be defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells. The rails of the rail system may comprise one or two tracks. Preferably both directions of rail comprise two tracks (double tracks), e.g., either as two parallel channels formed in a rail, or as a channel provided in each of a pair rail members that have been fastened to the other to form a rail. In such arrangements the grid opening and a track-width on each side defines the “grid cell”. In arrangements where one direction of rails has only a single track, the grid cell may extend a full rail-width on those sides.

In an aspect of the automated storage and retrieval system, the footprint of the second module of the container handling vehicle may be about the size of a grid cell of the rail system, and the first module and the third module may have a footprint less than the area of half a grid cell. I.e. the first module and the third module may extend less than 50 percent into the neighboring grid cell.

It is further described a method of assembling a container handling vehicle from a kit of parts as defined above, the method comprising the steps of:
assembling the first module of the vehicle frame, the first module comprising:
   the first wheel and the second wheel of the first set of wheels,
   the first wheel and the fourth wheel of the second set of wheels;
   one or more wheel drive motors
assembling the third module of the vehicle frame, the third module comprising:
   the third wheel and the fourth wheel of the first set of wheels,
   the second wheel and the third wheel of the second set of wheels;
   one or more drive motors
connecting the first, second and third modules together in order to form a vehicle having configuration with central cavity, or with one or more outwardly projecting cantilever lifting arms.

One aspect can be described as follows:
A container handling vehicle for operation on an automated storage and retrieval system, the automated storage and retrieval system comprising a two-dimensional rail system comprising a first set of parallel rails in a horizontal plane arranged to guide movement of container handling vehicles in a first direction across the top of a frame structure, and a second set of parallel rails in the horizontal plane arranged perpendicular to the first set of parallel rails to guide movement of the container handling vehicles in a second direction which is perpendicular to the first direction, the container handling vehicle comprises:
a vehicle frame assembled from a first module, a second module and a third module arranged side-by-side, wherein the first module is arranged next to the third module, and the second module is connected to the first module and/or the third module such that the second module projects outward to form one or more cantilever arms for lifting a storage container
a first set of wheels comprising a first wheel, a second wheel, a third wheel and a fourth wheel for driving in the first direction;
a second set of wheels comprising a first wheel, a second wheel, a third wheel and a fourth wheel for driving in the second direction;
a first drive motor for driving the first wheel and the second wheel of the first set of wheels;
a second drive motor for driving the third wheel and the fourth wheel (of the first set of wheels;
and wherein the first wheel and the second wheel of the first set of wheels and the first drive motor are arranged in the first module, and the third wheel and the fourth wheel of the first set of wheels and the second drive motor are arranged in the third module.

In the present specification the term “storage container” is intended to mean any goods holder unit having a bottom and side portions suitable for releasable connection to the container handling vehicle's lifting device, and may be in the form of, for example, a bin, a tote, a tray or similar. The side portions may preferably comprise gripping recesses. The side portions are preferably sidewalls. The height of the sidewalls may vary depending on the intended use of the automated storage and retrieval system and the goods to be stored. Gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The disclosed automated storage and retrieval system and methods may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the disclosure. The drawings show aspects and examples of the disclosure, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIGS. 6A and 6B sow different perspective views of a container handling vehicle according to configuration “a” operating on a rail system of an automated storage and retrieval system;

FIG. 7A is an exploded view of the container handling vehicle of FIGS. 6A and 6B without side and top panels;

FIG. 7B shows a container handling vehicle where a first coupler link and a first wheel and a fourth wheel of the first set of wheels have been removed to better illustrate the components behind said parts;

FIG. 7C is a perspective view of a wheel lift assembly of the container handling vehicle;

FIG. 7D is a side perspective view of the container handling vehicle according to configuration “a” showing a first lifting device motor in a first module of the container handling vehicle;

FIG. 8A is a top view of the container handling vehicle according to configuration “a” of FIGS. 6A and 6B showing first, second and third modules of the container handling vehicle;

FIG. 8B shows footprints of the respective first, second and third modules of the container handling vehicle according to configuration “a”;

FIGS. 9A-9C are different views of the container handling vehicle of FIGS. 6-8 with the wheels connected to the wheel lift mechanism in the tracks of the rail system; and

FIG. 10 is an exploded view of certain of the a components of a modular container handling vehicle as well as illustrating various components of a kit of parts for assembling such a vehicle.

FIG. 11 is a side view of a modular vehicle assembled to form a vehicle having a single, outwardly projecting cantilever arm.

FIG. 12 is a side view of a modular vehicle assembled to form a vehicle having a two outwardly projecting cantilever arms.

### DETAILED DESCRIPTION

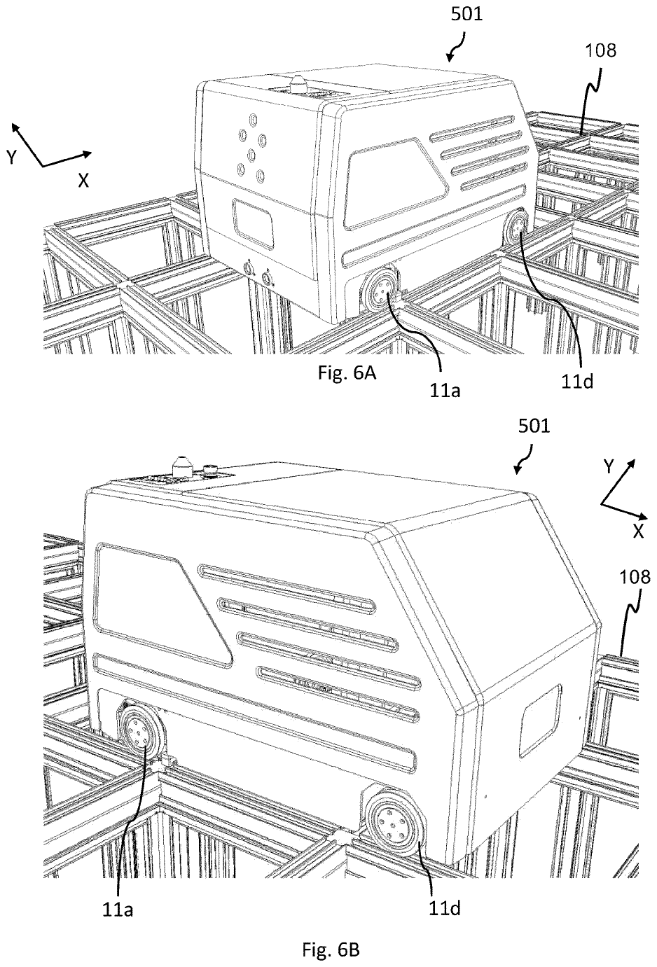

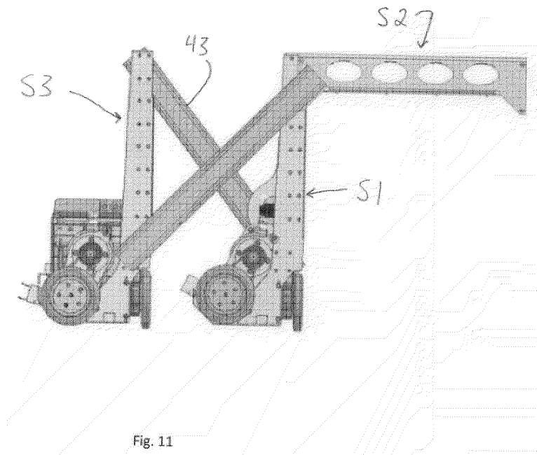

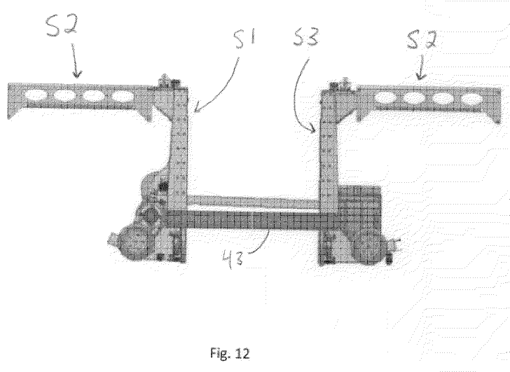

In the following, aspects will be discussed in more detail with reference to the appended drawings. It should be understood, however, that the drawings are not intended to limit the disclosure to the subject-matter depicted in the drawings. Aspects will first be described with reference to FIG. 6A to FIG. 9C, illustrating a modular vehicle assembled to have a central cavity. Thereafter, examples of the vehicle assembled to have one or more cantilever arms will be described with reference to FIGS. 11 and 12.

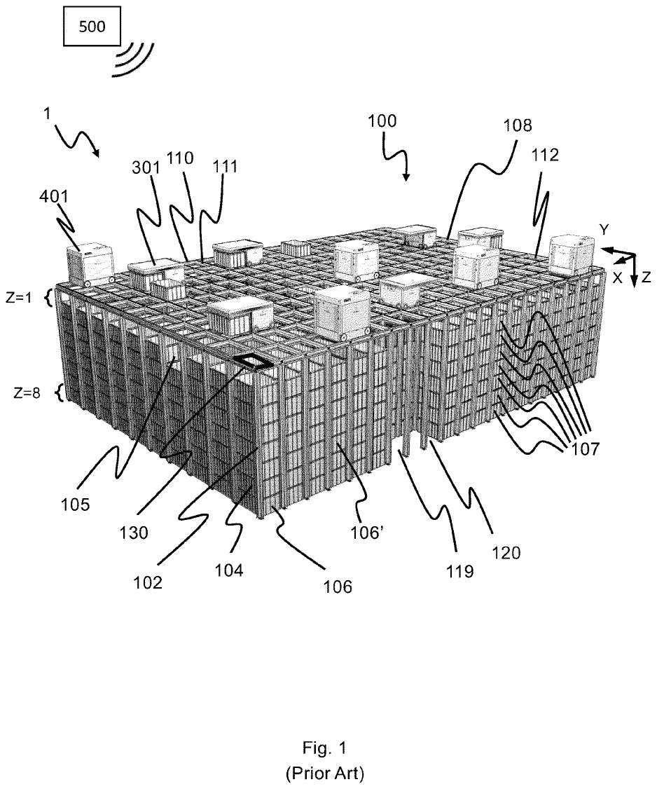

A frame structure 100 of the automated storage and retrieval system 1 may be constructed in a similar manner to the prior art frame structure 100 described above in connection with FIG. 1. That is, the frame structure 100 may comprise a number of upright members 102, and comprise a first, upper rail system 108 extending in the X direction and Y direction.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

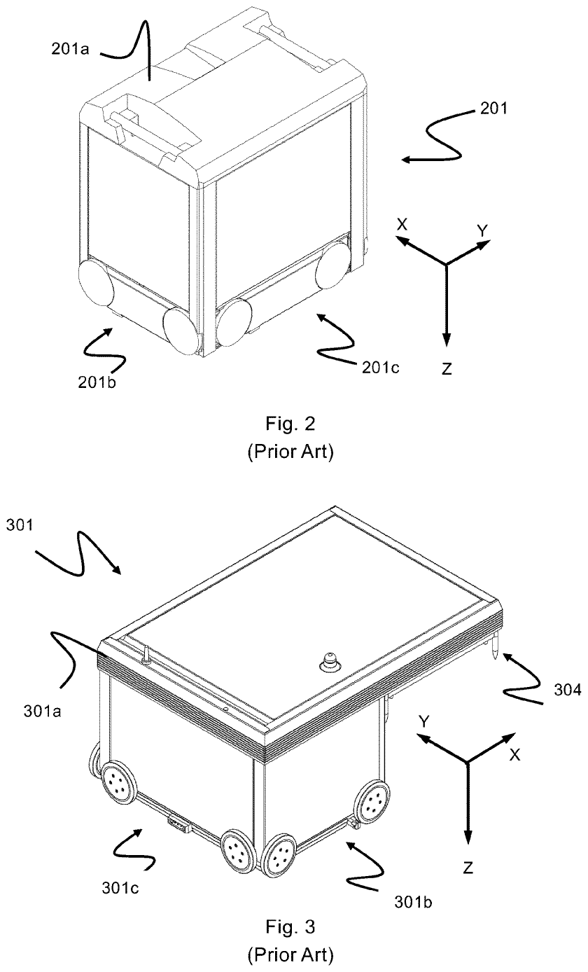

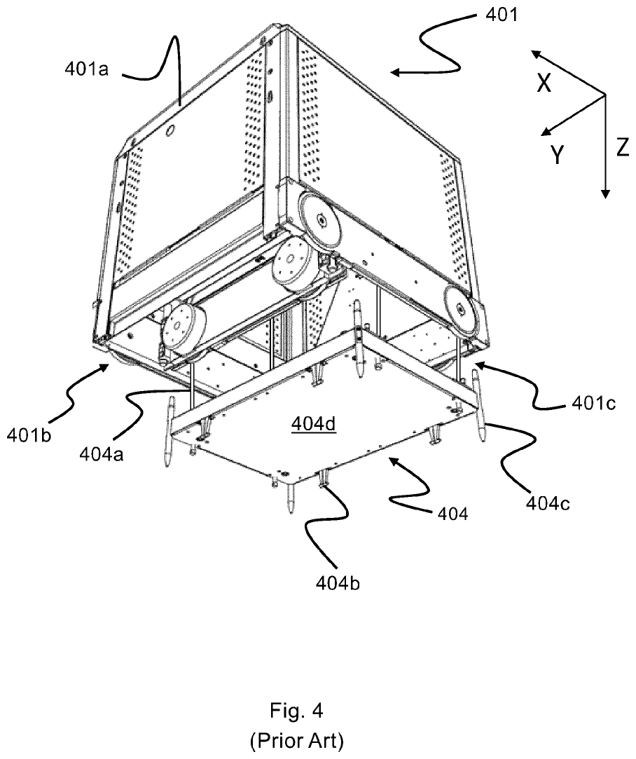

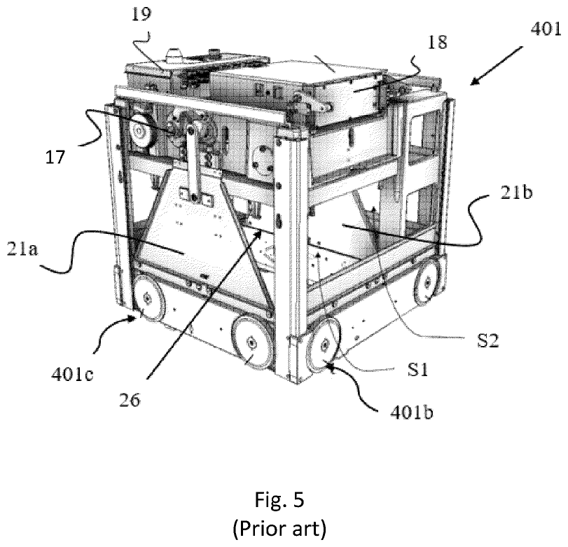

The prior art container handling vehicles comprising a cavity for accommodating a storage container or having a cantilever arm, see FIGS. 2, 3, 4 and 5, have certain advantageous features. In particular, the guidance/support provided to a storage container when accommodated in the cavity as in FIG. 2 entails that the vehicles may have increased acceleration/deceleration relative to the cantilevered container handling vehicle 301 shown in FIG. 3. However, the potential increase in acceleration/retardation may not be fully realized due to potential instability of the vehicles. The potential instability is caused by both vehicles 201,401 having many of the drive, power, control and lifting components arranged above the cavity, providing a high centre of gravity. Vehicles having a cantilever arm as in FIG. 3 therefore in certain situations have advantages over the central cavity type of vehicle.

FIGS. 6A and 6B show different perspective views of a container handling vehicle 501 operating on a rail system of an automated storage and retrieval system.

The container handling vehicle 501 is suitable for use in prior art storage systems as discussed in the background module and shown in FIG. 1 and discussion in relation to those systems above can apply also to the improved container handling vehicle described herein.

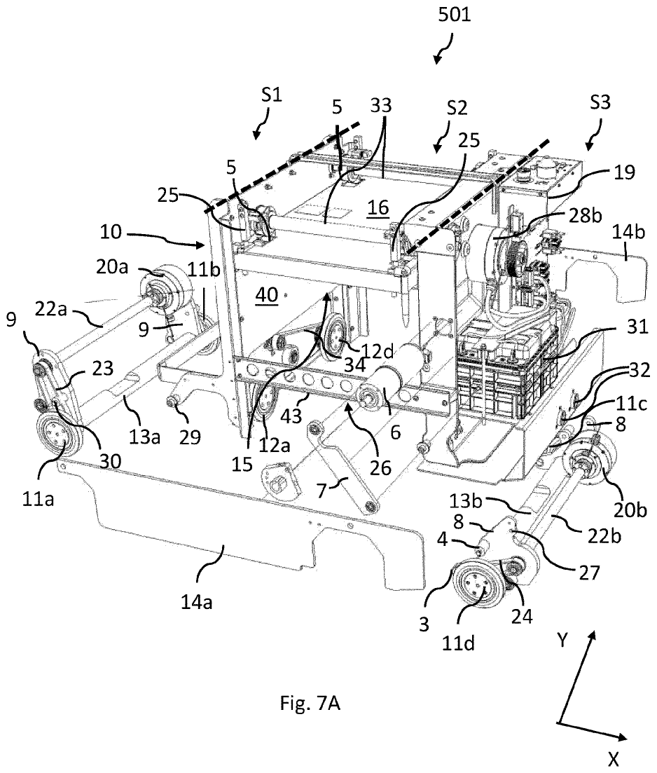

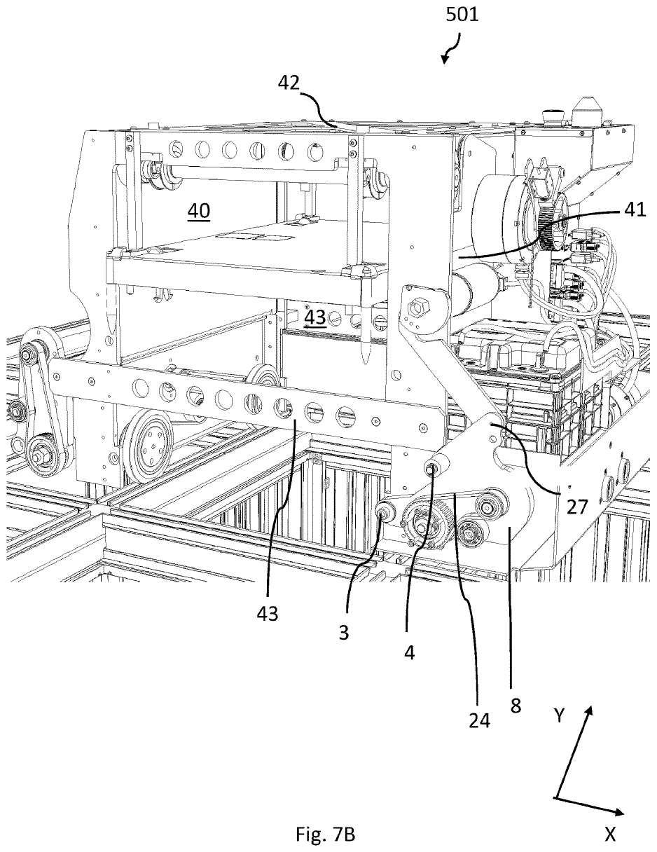

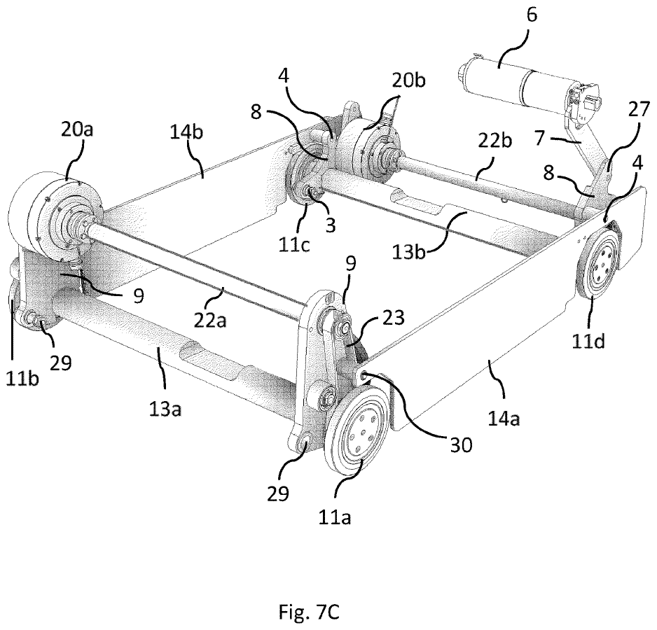

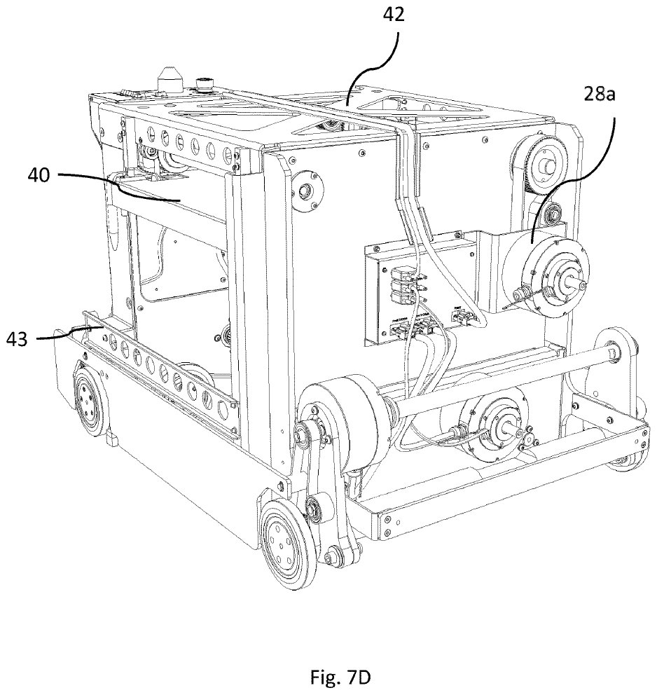

FIG. 7A is an exploded view of the container handling vehicle 501 of FIGS. 6A and 6B without side and top panels.

The container handling vehicle 501 features a vehicle frame 10 defining a first module S1, a second module S2 and a third module S3 of the container handling vehicle 501 arranged side-by-side. The first module S1 is arranged on a first side of the second module S2 and the third module is arranged on an opposite second side of the second module S2.

The second module S2 comprises a lifting device 15 for lifting a storage container 106, and provides a cavity 26 in which the storage container 106 (storage container 106 not shown in FIG. 7A) may be accommodated. The lifting device 15 has a lifting frame 16 and two rotatable lifting shafts 33 configured to raise and lower the lifting frame 16 via a set of lifting bands 5. A first lifting device motor 28a for driving the lifting device 15, i.e. rotating the lifting shafts 33, is arranged in the first module S1.

The container handling vehicle 501 comprises a first set of wheels 11 and a second set of wheels 12 configured to move the container handling vehicle 501 upon on a rail system 108 (not shown in FIG. 7A, see e.g. FIG. 1). The rail system 108 (see FIG. 1) comprises a first set of parallel rails 110 and a second set of parallel rails 111 arranged perpendicular to the first set of rails 110. The rail system 108 is arranged in a horizontal, grid-based manner.

The first set of wheels 11 comprises a first wheel 11a, a second wheel 11b, a third wheel 11c and a fourth wheel 11d for driving in the first direction X. The first wheel 11a and the second wheel 11b of the first set of wheels 11 are arranged on opposite portions of the first module S1. A first drive motor 20a for driving the first wheel 11a and the second wheel 11b of the first set of wheels 11 is arranged in the first module S1. A first drive shaft 22a is rotatably connected to the first drive motor 20a and extends between the two opposing ends of the first module S1 where the first wheel 11a and the second wheel 11b of the first set of wheels 11 are arranged. Drive bands 23 (only one drive band shown in FIG. 7A) extends between the first drive shaft 22a and the respective first wheel 11a and second wheel 11b of the first set of wheels such that rotation of the first drive motor 20a is transferred to the first wheel 11a and the second wheel 11b via the first drive shaft 22a and the drive bands 23.

The third wheel 11c and the fourth wheel 11d of the first set of wheels 11 are arranged on opposite portions of the third module S3. A second drive motor 20b for driving the third wheel 11c and the fourth wheel 11d of the first set of wheels 11 is arranged in the third module S3. Similar to the setup in the first module S1, a second drive shaft 22b is rotatably connected to the second drive motor 20b and extends between the two opposing ends of the third module S3 where the third wheel 11c and the fourth wheel 11d of the first set of wheels 11 are arranged. Drive bands 24 (only one drive band shown in FIG. 7A) extends between the second drive shaft 22b and the respective third wheel 11c and fourth wheel 11d of the first set of wheels such that rotation of the second drive motor 20b is transferred to the third wheel 11c and the fourth wheel 11d via the first drive shaft 22b and the drive bands 24.

All of the wheels 11a, 11b, 11c, 11d of the first set of wheels 11 are thus driven or motorized wheels.

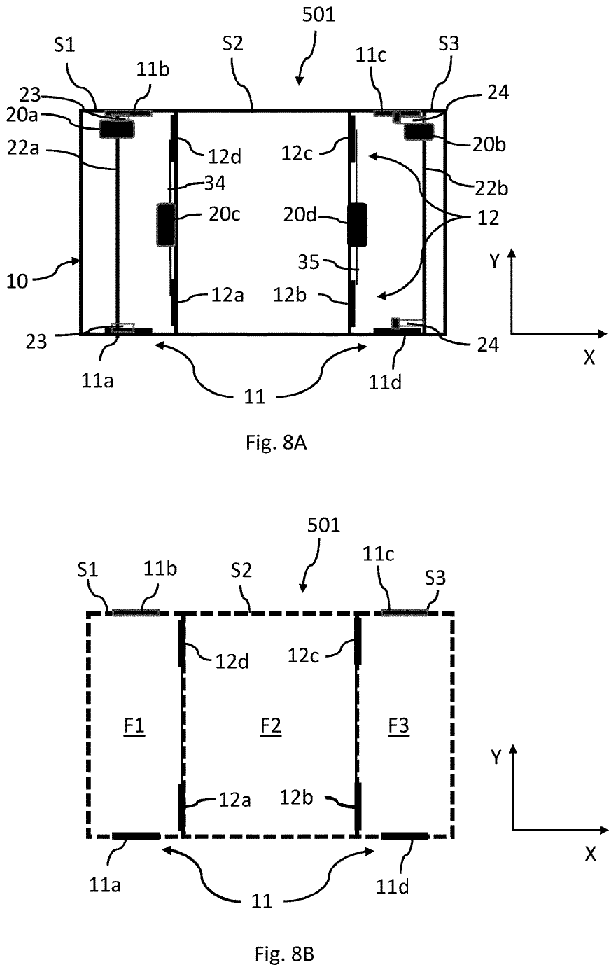

The second set of wheels 12 comprises a first wheel 12a, a second wheel 12b (not shown in FIG. 7A, see e.g. FIG. 8A), a third wheel 12c (not shown in FIG. 7A, see e.g. FIG. 8A) and a fourth wheel 12d for driving in the second direction Y. The first wheel 12a and the fourth wheel 12d are arranged on one side of the second module S2 and the second wheel 12b and the third wheel 12c are arranged on an opposite side of the second module S2. The first wheel 12a and the fourth wheel 12d are arranged in a common vertical plane such that they are mutually arranged to drive in the same underlying track Similarly, the second wheel 12b and the third wheel 12c are arranged in a common vertical plane such that they are mutually arranged to drive in the same underlying track.

To allow a change of direction in which the container handling vehicle 501 travels upon the rail system 108, the first set of wheels 11 is arranged to be moveable in a vertical direction Z relative to the vehicle frame 10. The first set of wheels 11 may move between an upper position, in which the second set of wheels 12 allows movement of the vehicle 501 along the second direction Y, and a lower position, in which the first set of wheels 11 allows movement of the vehicle 501 along the first direction X.

The vertical movement of the first set of wheels 11 is obtained by a wheel lift mechanism featuring pivotable first and second wheel links 8,9 connected by coupler links 14a, 14b and driven by an actuator assembly.

In the wheel lift mechanism, the fourth wheel 11d of the first set of wheels 11 is mounted to the corresponding first wheel link 8 and the third wheel 11c of the first set of wheels 11 is mounted to the corresponding first wheel link 8. The first wheel links 8 comprising a first pivot coupling 3 and a second pivot coupling 4. The first wheel links 8 are pivotably connected to the vehicle frame 10 by the respective first pivot couplings 3.

Similarly, each of the first wheel 11a and the second wheel 11b of the first set of wheels 11 is mounted to a corresponding second wheel link 9 comprising a third pivot coupling 29 and a fourth pivot coupling 30. The second wheel links 9 are pivotably connected to the vehicle frame 10 by the respective third pivot coupling 29.

The second wheel link 9 supporting the first wheel 11a of the first set of wheels 11 and the first wheel link 8 supporting the fourth wheel 11d of the first set of wheels are connected via the respective second and fourth pivot couplings 4,30 by a first coupler link 14a. The first wheel link 8 supporting the fourth wheel 11d and the second wheel link 9 supporting the first wheel 8a are connected via the respective second and fourth pivot couplings 4,30 by a second coupler link 14b. The first coupler link 14a and the second coupler link 14b extend along opposite sides of the cavity 26 in the first module S1.

The first coupler link 14a and the second coupler link 14b may be plate-shaped as shown, and function as both force or movement transferring elements between the first wheel links 8 and the second wheel links 9, and as bodywork closing off (or at least providing a barrier for) two lower sides of the vehicle. The dual function of the coupler links 14a, 14b provides a cost efficient, lightweight and simple mechanical solution.

The first module S1 comprises a first cross-member 13b connected to both second wheel links 9. The first cross-member 13a is configured to fix the angular position of the second wheel links 9 relative to each other, such that the second wheel links 9 will move in unison around their respective third pivot coupling 29.

Similarly, the third module S3 comprises a second cross-member 13b connected to both first wheel links 8. The second cross-member 13b is configured to fix the angular position of the first wheel links 8 relative to each other, such that the first wheel links 8 will move in unison around their respective first pivot coupling 3.

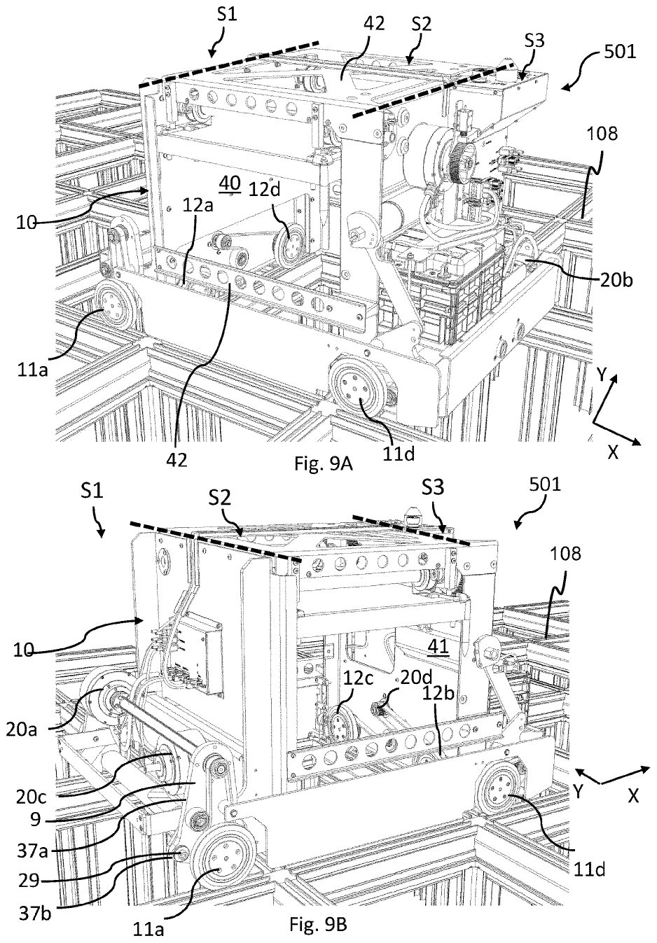

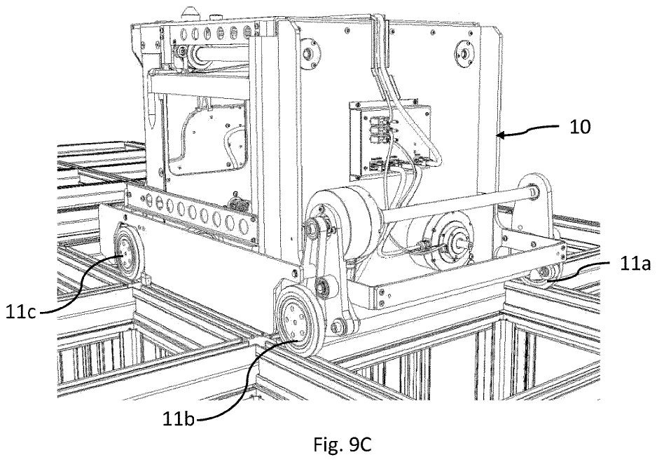

The actuator assembly is arranged in the third module S3 and features a wheel lift motor 6 and an actuator link 7. The actuator link 7 is connected to one of the first wheel links 8 by a fifth pivot coupling 27. The actuator assembly is configured to move the first wheel links 8 around the respective first pivot couplings 3 between a first angular position and a second angular position. The movement of the first wheel links 8 is transferred to the second wheel links 9 via the first coupler link 14a and the second coupler link 14b, such that the first set of wheels 11 is in the upper position, see FIGS. 7A-7C, or the lower position, see FIGS. 9A-9B, when the first wheel links 8 are in the first angular position and the second angular position, respectively.

The first coupler link 14a and the second coupler link 14b are configured to move in the first direction X towards the first wheel 11a and the second wheel 11b of the first set of wheels, respectively, when the first wheel links 8 are moved from the second angular position to the first angular position, and configured to move in the first direction X towards the third wheel 11c and the fourth wheel 11d of the first set of wheels 11, respectively, when the first wheel links 8 are moved from the first angular position to the second angular position.

Each of the second wheel links 9 comprises a first edge module 37a (see FIG. 9B) extending upwards from the level of the third pivot coupling 29 and a second edge module 37b (see FIG. 9B) extending downwards from the level of the third pivot coupling 29. The first edge module 37a and the second edge module 37b face away from the connected first wheel link 8 and are inclined relative to each other such that the second wheel link 9 does not extend beyond an outer side of the vehicle frame 10 when moved around the third pivot coupling 29.

The second drive shaft 22b and the second cross-member 13b are configured to move in parallel when the first wheel links 8 are moved between the first and second angular position. The second drive shaft 22b and the second cross-member 13b are configured to move in unison with the first wheel links 9 between the first and second angular position.

Similarly, the first drive shaft 22a and the first cross-member 13a are configured to move in parallel when the second wheel links 9 are moved between the first and second angular position. The first drive shaft 22a and the first cross-member 13a are configured to move in unison with the second wheel links 9 between the first and second angular position.

By moving the first drive shaft 22a, the second drive shaft 22b, the first cross-member 13a and the second cross-member 13b in unison with the respective second wheel link 9 and first wheel links 8, both excessive wear of the drive bands 23,24 due to stretching, and service involving tightening of the drive bands 23,24, are minimized. In this way, the relative mounting positions of the wheels and their respective drive motors can remain fixed during the angular motion of the first and second wheel links 8,9, such that belt tension in the drive bands 23,24 remains constant during raising and lowering of the wheels.

FIG. 7D is a side perspective view of the container handling vehicle 501 showing a second lifting device motor 28b in the third module S3 of the container handling vehicle 501.

FIG. 8A is a top view of the container handling vehicle of FIGS. 6A and 6B showing first, second and third modules S1,S2,S3 of the container handling vehicle 501. As disclosed, the container handling 501 may comprise a third drive motor 20c for driving the first wheel 12a and the fourth wheel 12d of the second set of wheels 12.

The third drive motor 20c is arranged in the first module S1. The third drive motor 20c may drive the connected first wheel 12a and fourth wheel 12d of the second set of wheels 12 via a drive band 34.

Further referring to FIG. 8A, the container handling vehicle 501 may comprise a fourth drive motor 20d for driving the second wheel 12b and the third wheel 12c of the second set of wheels 12. The fourth drive motor 20d is arranged in the third module S3. The fourth drive motor 20d may drive the connected second wheel 12b and third wheel 12c of the second set of wheels 12 via a drive band 35.

Power to drive the motors of the container handling vehicle is provided by a rechargeable battery 31 (and/or high power capacitors) arranged in the third module S3. The rechargeable battery 31 is connected to a set of electrodes 32. The electrodes 32 are configured to receive power from a charging station. The two electrodes 32 are arranged on opposite sides of a vertical centre plane of the container handling vehicle, the vertical centre plane extending in the first direction X. An advantageous effect of having the electrodes 32 separated in this manner is that lateral skewing of the container handling vehicle relative to the first direction X during initial connection to a charging station is minimized. A suitable charging station is disclosed in e.g. PCT/EP2021/074340.

A control unit 19 for controlling at least the drive components (i.e. the first, second, third and fourth drive motors 20a,20b,20c,20d, the wheel lift motor 6 and the first and second lifting device motors 28a,28b) is arranged in the third module S3.

A set of replaceable distance pins 25 are arranged above the lifting frame 16. The distance pins 25 are configured to interact with switches (not shown) on an upper portion of the lifting frame 16 when the lifting frame 16 is in an upper position. The distance pins help to stabilize a shallower container 106 in the cavity (and they can then be removed when the vehicle is being used with larger containers).

The distance pins 25 ensure that the efficiency of the container handling vehicle 501 may be optimized with respect to the height of the storage containers 106 being lifted. If the container handling vehicle 501 is to be used for higher storage containers, shorter distance pins 25 may be installed to ensure that the containers are not lifted higher than required for entering the cavity 26.

In alternative aspect, the distance pins 25 may be adjustable, i.e. have an adjustable height, instead of being replaceable. Adjustable distance pins may for instance be obtained by having telescopic or foldable distance pins.

Each of the container handling vehicles 501 comprise four of the distance pins 25 arranged to interact with the lifting frame 16 at four corner modules. The distance pins 25 may also be configured to stabilize the lifting frame 16, and any storage container 106 connected thereto, when the lifting frame 16 is in an upper position.

FIGS. 9A-9C are different views of the container handling vehicle of FIGS. 6-8 with the wheels connected to the wheel lift mechanism in the tracks of the rail system. In the illustration, the first direction (x direction) is a smaller dimension of the grid cell 130 as compared to the second direction (y direction). The extension of the container handling vehicle 501 is preferable less than two cells in the first direction (i.e. the x direction). This ensures that the container handling vehicle 501 is relatively compact and proportional in the first direction (x direction) and the second direction (y direction).

FIG. 11 illustrates an aspect where the modules are assembled to form a vehicle configured to have a cantilever type lifting arm. According to this aspect, the first and third modules comprising drive wheels are connected next to each other, with the second module connected to either the first or third module such that the second module projects outward. Cross members 43 are connected between the first and third modules. Coupler links 14a and 14b may be connected between the first and third modules in the manner described above. One skilled in the art will recognize that in the configuration shown in FIG. 11, the length of cross members 43 and/or coupler links 14a and 14b may be different than described above, for example they may be shorter since in this configuration the first and third modules are closer together than in the central cavity configuration. A kit of part may thus comprise cross members 43 and coupler links 14 of various dimensions.

FIG. 12 illustrates an aspect where the modules are assembled to form a vehicle configured to have two cantilever type lifting arms. According to this aspect, the first and third modules comprising drive wheels are connected next to each other, with the second module connected to both the first and third module such that two second module projects outward. As with the illustration in FIG. 11, cross members 43 are connected between the first and third modules and coupler link 14a and 14b may be connected between the first and third modules in the manner described above. While not illustrated, it would be possible to modify the aspect in FIG. 12 to have an additional second module between the first and third modules, thus providing a vehicle with both central cavity and cantilever arm arrangements.

The configuration of the presently disclosed modular container handling vehicle 501 allows for a highly efficient method of assembly since the first module S1, the second module, the third module S3, and a major part of the components making up the vehicle may constitute preassembled vehicle modules. The method of assembling may comprise the steps of:
providing a first module S1 of the vehicle, the first module S1 comprising:
   the first wheel 11a and the second wheel 11b of the first set of wheels 11,
   the first drive motor 20a,
   the first wheel links 8,
   the first wheel 12a and the fourth wheel 12d of the second set of wheels 12;
providing a third module S3 of the vehicle, the third module comprising:
   the third wheel 11c and the fourth wheel 11d of the first set of wheels 11,
   the second drive motor 20b,
   the second wheel links 9,
   the second wheel 12b and the third wheel 12c of the second set of wheels 12,
providing and connecting one or more second modules S2 of the vehicle to the first module S1 of the vehicle and/or the third module S3 of the vehicle frame 10, such that the vehicle is configured in one of the following longitudinal configurations:
   a. first module, second module, third module
   b. first module, third module, second module
   c. second module, first module, third module, second module
interconnecting the first wheel links 8 to the respective second wheel links 9 by the first coupler link 14a and the second coupler link 14b
connecting cross members 43 between the first and third modules.

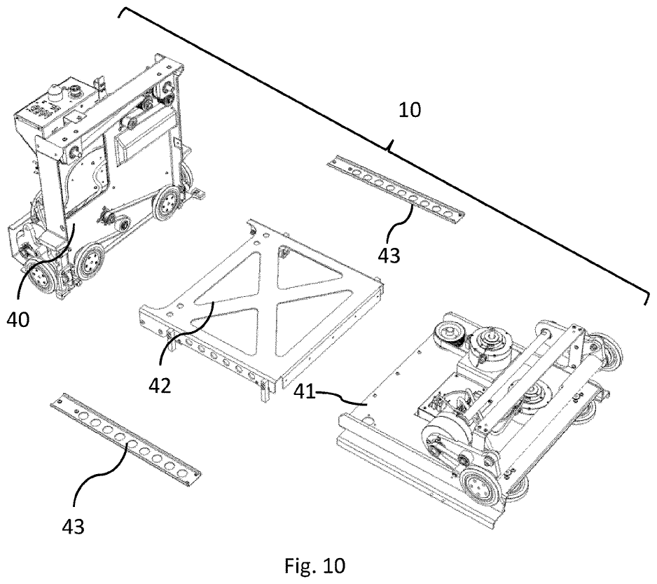

FIG. 10 is an exploded view of the components for assembling a modular vehicle, which may comprise certain components of a kit of parts for assembling a modular vehicle frame 10 of the container handling vehicle of FIG. 6-9, 11 or 12. As shown, the vehicle frame 10 comprises a first vertical subframe 40 forming part of the first module S1 and a second vertical subframe 41 forming part of the third module S3. The container handling vehicle 501 also comprises a horizontal upper member 42 forming part of the second module S2. The horizontal upper member 42 is configured to be arranged above a central cavity 26 when arranged as configuration “a” or projecting outward as a cantilever arm when arranged as configuration “b” or “c”.

The horizontal upper member 42 is connectable to the first vertical subframe 40 and/or the second vertical subframe 41. The first and second vertical subframes 40,41 are configured to be arranged on opposite sides of the cavity 26, or next to each other as in FIGS. 11 and 12.

The vehicle frame 10 is further disclosed with side cross-members 43 configured to be arranged between the first and third modules. The side cross-members 43 may be horizontal members connected to lower portions of the first and second vertical subframes 40,41, or may be arranged diagonally as shown in FIGS. 11 and 12, or in any other appropriate manner.

In the preceding description, various aspects of the independent claims have been described. For purposes of explanation, specific numbers, systems and configurations were set forth in order to provide a thorough understanding of the system and its workings. However, this description is not intended to be construed in a limiting sense. Various modifications and variations of the disclosure which are apparent to persons skilled in the art to which the disclosed subject matter pertains, are deemed to lie within the scope of the presently claimed invention as defined in the attached claims.

### LIST OF REFERENCE NUMBERS

| | |
|---|---|
| 1 | Prior art automated storage and retrieval system |
| 3 | First pivot coupling |
| 4 | Second pivot coupling |
| 5 | Lifting bands |
| 6 | Wheel lift motor |
| 7 | Actuator link |
| 8 | First wheel link |
| 9 | Second wheel link |
| 10 | Vehicle frame |
| 11 | First set of wheels |
| 11a | First wheel in first set of wheels |
| 11b | Second wheel in first set of wheels |
| 11c | Third wheel in first set of wheels |
| 11d | Fourth wheel in first set of wheels |
| 12 | Second set of wheels |
| 12a | First wheel in second set of wheels |
| 12b | Second wheel in second set of wheels |
| 12c | Third wheel in second set of wheels |
| 12d | Fourth wheel in second set of wheels |
| 13a | First cross-member |
| 13b | Second cross-member |
| 14a | First coupler link |
| 14b | Second coupler link |
| 15 | Lifting device |
| 16 | Lifting frame |
| 17 | Wheel lift shaft |
| 18 | Replaceable battery |
| 19 | Control unit |
| 20a | First drive motor |
| 20b | Second drive motor |
| 20c | Third drive motor |
| 20d | Fourth drive motor |
| 21a, 21b | Wheel lift plate |
| 22a | First drive shaft |
| 22b | Second drive shaft |
| 23 | Drive bands first and second wheel of first set of wheels |
| 24 | Drive bands third and fourth wheel of first set of wheels |
| 25 | Distance pin |
| 26 | Cavity |
| 27 | Fifth pivot coupling |
| 28a | First lifting device motor |
| 28b | Second lifting device motor |
| 29 | Third pivot coupling |
| 30 | Fourth pivot coupling |
| 31 | Battery |
| 32 | Electrode |
| 33 | Lifting shafts |
| 34 | Drive band first and fourth wheel of second set of wheels |
| 35 | Drive band second and third wheel of second set of wheels |
| 37a | First edge module |
| 37b | Second edge module |
| 38 | Wheel hub motors |
| 40 | First vertical subframe |
| 41 | Second vertical subframe |
| 42 | Horizontal upper member |
| 43 | Side cross-member |
| 100 | Frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel rails (in first direction (X)) |
| 111 | Second set of parallel rails (in second direction (Y)) |
| 112 | Access opening |
| 130 | Grid cell |
| 201 | Prior art container handling vehicle |
| 201a | Vehicle body of the container handling vehicle 201 |
| 201b | Drive means/wheel arrangement/first set of |
| | wheels in first direction (X) |
| 201c | Drive means/wheel arrangement/second set of |
| | wheels in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 501 | Container handling vehicle |
| F1 | Footprint of first module |
| F2 | Footprint of second module |
| F3 | Footprint of third module |
| S1 | First module |
| S2 | Second module |
| S3 | Third module |
| X | First direction |
| Y | Second direction |
| Z | Third direction |

1.-19. (canceled)

20. A container handling vehicle for operation on an automated storage and retrieval system, the automated storage and retrieval system comprising a two-dimensional rail system comprising a first set of parallel rails in a horizontal plane arranged to guide movement of container handling vehicles in a first direction across the top of a frame structure, and a second set of parallel rails in the horizontal plane arranged perpendicular to the first set of parallel rails to guide movement of the container handling vehicles in a second direction which is perpendicular to the first direction, the container handling vehicle comprises:
a vehicle frame assembled from a first module, a second module and a third module arranged side-by-side, wherein the first module is arranged next to the third module, and the second module is connected to the first module and/or the third module such that the second module projects outward to form one or more cantilever arms for lifting a storage container;
a first set of wheels comprising a first wheel, a second wheel, a third wheel, and a fourth wheel for driving in the first direction;
a second set of wheels comprising a first wheel, a second wheel, a third wheel and a fourth wheel for driving in the second direction;
a first drive motor for driving the first wheel and the second wheel of the first set of wheels;
a second drive motor for driving the third wheel and the fourth wheel of the first set of wheels;
and wherein the first wheel and the second wheel of the first set of wheels and the first drive motor are arranged in the first module, and the third wheel and the fourth wheel of the first set of wheels and the second drive motor are arranged in the third module.

21. The container handling vehicle according to claim 20, comprising a third drive motor for driving the first wheel and the fourth wheel of the second set of wheels, and wherein the third drive motor is arranged in the first module.

22. The container handling vehicle according to claim 21, comprising a fourth drive motor for driving the second wheel and the third wheel of the second set of wheels, and wherein the fourth drive motor is arranged in the third module.

23. The container handling vehicle according to claim 20, wherein the container handling vehicle comprises a first lifting device motor, and wherein the first lifting device motor is arranged in the first module.

24. The container handling vehicle according to claim 23, wherein the container handling vehicle comprises a second lifting device motor, and wherein the second lifting device motor is arranged in the third module.

25. The container handling vehicle according to claim 20, wherein the first set of wheels being arranged to be movable in a vertical direction relative to the vehicle frame between an upper position in which the second set of wheels allows movement of the vehicle along the second direction, and a lower position in which the first set of wheels allows movement of the vehicle along the first direction; and wherein:
each of the third wheel and the fourth wheel of the first set of wheels is mounted to one of a pair of first wheel links, each first wheel link comprises a first pivot coupling and a second pivot coupling and each first wheel link is pivotably connected to the vehicle frame by the first pivot coupling;
each of the first wheel and the second wheel of the first set of wheels is mounted to one of a pair of second wheel links, each second wheel link comprises a third pivot coupling and a fourth pivot coupling and each first wheel link is pivotably connected to the vehicle frame by the third pivot coupling;
the first wheel link and the second wheel link are connected via the respective second and fourth pivot couplings by a first coupler link; and
the first wheel link and the second wheel link are connected via the respective second and fourth pivot couplings by a second coupler link,
and wherein the first coupler link and the second coupler link extend on opposite sides of the cavity between the first side and the second side of the second module.

26. The container handling vehicle according to claim 25, wherein the third module comprises an actuator assembly, the actuator assembly being arranged to move the first wheel links around the respective first pivot couplings between a first angular position and a second angular position, the movement of the first wheel links being transferred to the second wheel links via the first coupler link and the second coupler link, such that the first set of wheels is in the upper position or the lower position when the first wheel links are in the first angular position or the second angular position, respectively.

27. The container handling vehicle according to claim 26, wherein:
the first module comprises a first cross-member fixing the angular position of the second wheel links relative to each other, such that the second wheel links will move in unison around their respective third pivot coupling; and
the third module comprises a second cross-member fixing the angular position of the first wheel links relative to each other, such that the first wheel links will move in unison around their respective first pivot coupling; and
the actuator assembly is operatively connected to a wheel lift mechanism and is arranged to move the first wheel link around its first pivot coupling between the first angular position and the second angular position.

28. The container handling vehicle according to claim 26, wherein the actuator assembly comprises a wheel lift motor or a linear actuator.

29. The container handling vehicle according to claim 26, wherein at least one of the first wheel links comprises a fifth pivot coupling connected to the actuator assembly.

30. The container handling vehicle according to claim 26, wherein the actuator assembly comprises an actuator link pivotably connected to one of the first wheel links to drive rotation of the first wheel links.

31. The container handling vehicle according to claim 20, comprising:
a first drive shaft arranged in the first module and interconnecting the second wheel links, wherein the first drive shaft is operatively connected to drive the first wheel and the second wheel of the first set of wheels; and
a second drive shaft arranged in the third module and interconnecting the second wheel links, wherein the second drive shaft is operatively connected to drive the third wheel and the fourth wheel of the first set of wheels.

32. The container handling vehicle according to claim 20, wherein the vehicle frame comprises a first vertical subframe forming part of the first module and a second vertical subframe forming part of the third module and a horizontal upper member forming part of the second module, and wherein the horizontal upper member is arranged above the cavity.

33. The container handling vehicle according to claim 32, wherein the horizontal upper member is connected to the first vertical subframe and the second vertical subframe.

34. The container handling vehicle according to claim 32, wherein the vehicle frame comprises side cross-members arranged on opposite sides of the cavity.

35. The container handling vehicle according to claim 20, wherein the first module and the third module comprise their respective drive motors on hinged wheel assemblies for driving the respective wheels arranged in the respective first module and third module, and wherein the hinged wheel assemblies of the first module and the third module are connectable on opposite sides of the second module.

36. A method of assembling at least two different configurations of a container handling vehicle adapted for operation on a rail system of an automated storage and retrieval system, the method comprising the steps of:
providing a kit of parts comprising:
a first module comprising a first wheel and second wheel of a first set of wheels for driving of the vehicle in a first direction, a first wheel and a fourth wheel of a second set of wheels for diving of the vehicle in a second direction perpendicular to the first direction, one or more wheel drive motors, and a mechanism for selectively lifting the wheels of the first or second set of wheels in order to change direction of the vehicle;
a second module comprising a horizonal frame and a lifting device for lifting containers,
a third module comprising a third wheel and a fourth wheel of the first set of wheels, a second wheel and a third wheel of the second set of wheels, one or more wheel drive motors, and a mechanism for selectively lifting the wheels of the first or second set of wheels in order to change direction of the vehicle;
connecting the first module, third module and one or more second modules together such as to form a vehicle having a first longitudinal configuration comprising the first module, the third module, and the second module, or a second longitudinal configuration comprising the second module, first module, third module, and second module.

37. A method according to claim 26, wherein the kit of parts comprises components required to assemble a vehicle in the first longitudinal configuration.

38. A method according to claim 37, where the components of the kit comprise cross members and/or coupler links of at least two different lengths.

39. An automated storage and retrieval system, the automated storage and retrieval system comprising:
a two-dimensional rail system comprising a first set of parallel rails in a horizontal plane arranged to guide movement of container handling vehicles in a first direction across the top of a frame structure, and a second set of parallel rails in the horizontal plane arranged perpendicular to the first set of parallel rails to guide movement of the container handling vehicles in a second direction which is perpendicular to the first direction; and
at least one container handling vehicle comprising:
a vehicle frame assembled from a first module, a second module and a third module arranged side-by-side, wherein the first module is arranged next to the third module, and the second module is connected to the first module and/or the third module such that the second module projects outward to form one or more cantilever arms for lifting a storage container;
a first set of wheels comprising a first wheel, a second wheel, a third wheel, and a fourth wheel for driving in the first direction;
a second set of wheels comprising a first wheel, a second wheel, a third wheel and a fourth wheel for driving in the second direction;
a first drive motor for driving the first wheel and the second wheel of the first set of wheels;
a second drive motor for driving the third wheel and the fourth wheel of the first set of wheels; and
wherein the first wheel and the second wheel of the first set of wheels and the first drive motor are arranged in the first module, and the third wheel and the fourth wheel of the first set of wheels and the second drive motor are arranged in the third module.
